(19) United States
(12) Patent Application Publication
(10) Pub. No.: US 2021/0019723 A1
(43) Pub. Date: Jan. 21, 2021

(54) INTEGRATED AUTONOMOUS CHECKOUT SYSTEM

(71) Applicant: AHOLD DELHAIZE LICENSING SÀRL, Geneva (CH)

(72) Inventors: Michael KARNS, Exeter, RI (US); Scott MORRISON, Mansfield, MA (US); Smitha ARUNKUMAR, Quincy, MA (US)

(21) Appl. No.: 16/932,083

(22) Filed: Jul. 17, 2020

Related U.S. Application Data
(60) Provisional application No. 62/875,044, filed on Jul. 17, 2019.

(51) Int. Cl. G06Q 20/20; G06Q 20/18; G06Q 40/02; G06Q 20/10; G06Q 20/32; G06Q 20/42; G06Q 20/40; G06Q 20/08; G06Q 30/02; G06Q 20/36; G06Q 20/06; G06K 7/14; G06K 7/10; G06F 21/31

(52) U.S. Cl. CPC G06Q 20/206; G06K 2007/10524; G06Q 20/201; G06Q 40/02; G06Q 20/108; G06Q 20/3226; G06Q 20/425; G06Q 20/3255; G06Q 20/40145; G06Q 20/3267; G06Q 20/0855; G06Q 20/3274; G06Q 20/3278; G06Q 30/0226; G06Q 20/3678; G06Q 20/0655; G06Q 20/3674; G06K 7/1417; G06K 7/10881; G06F 21/31; G06Q 2220/00; G06Q 20/18

(57) ABSTRACT

An integrated autonomous checkout system is disclosed, including a hand-held tallying device, an identity authentication module, and a payment module. The hand-held tallying device includes a scanner, memory, and a hand-held tallying device program encoded in the memory for recording a tally of items scanned with the scanner. The hand-held tallying device is in communication with at least one remote server. The identity authentication module includes an identity authentication module program configured to verify an identity of a user as a first authentication factor. The payment module includes a payment module program configured to receive a price corresponding to the tally and direct an electronic payment from an account associated with the user to a seller in response to an instruction provided by the user. The payment module includes a second authentication factor different from the first authentication factor.

### RELATED APPLICATIONS

This application claims the benefit of and priority to U.S. Provisional Application No. 62/875,044 entitled “System and Method of Shopping,” filed Jul. 17, 2019, which is hereby incorporated by reference in its entirety.

### FIELD OF THE INVENTION

The present invention is directed to an integrated autonomous checkout system. More specifically, the present invention is directed to an integrated autonomous checkout system including a hand-held tallying device, an identity authentication module, and a payment module, the integrated autonomous checkout system including two-factor authentication.

### BACKGROUND OF THE INVENTION

Merchant supplied devices, such as a JOYA TOUCH™, are currently used for various retail applications including self-shopping. Customers may scan items and add them to their shopping cart as they move throughout the store. In conventional systems, once the customer indicates they have completed their shopping trip, such as by pressing checkout on a Joya device, a barcode is generated, and the customer is instructed to proceed to a self-checkout lane or staffed lane to pay for the items in their basket. Once the customer reaches the lane and scans the barcode, the transaction is retrieved to the point of sale/self-checkout lane device and the customer completes the transaction as if the items had been scanned at that lane.

The customer can pay for their order via the conventional payment options at the checkout lane. In some cases, the customer may pay for their order using electronic payment options, such as a virtual wallet. If the customer is using a virtual wallet, such as a mobile application on their own iOS and/or Android device, they have the option to pay for their order from the mobile wallet. To access the mobile wallet, the customer must authenticate themselves, via username and password, and the device must be associated with that wallet.

It would be desirable in the art to enable the customer to authenticate to a virtual wallet via the merchant supplied device and complete their purchase without having to use a self-checkout or staffed checkout. However, this creates a problem because, unlike a mobile phone that is generally owned by, and thus unique, to the customer, scanning devices are owned by the store and used by many different people before and after that customer completes his or her trip.

### BRIEF DESCRIPTION OF THE INVENTION

In one exemplary embodiment, an integrated autonomous checkout system includes a hand-held tallying device, an identity authentication module, and a payment module. The hand-held tallying device includes a scanner, memory, and a hand-held tallying device program encoded in the memory for recording a tally of items scanned with the scanner. The hand-held tallying device is in communication with at least one remote server. The identity authentication module includes an identity authentication module program configured to verify an identity of a user as a first authentication factor. The payment module includes a payment module program configured to receive a price corresponding to the tally and direct an electronic payment from an account associated with the user to a seller in response to an instruction provided by the user. The payment module includes a second authentication factor different from the first authentication factor.

### BRIEF DESCRIPTION OF THE DRAWINGS

FIG. 1 is a schematic view of an integrated autonomous checkout system, according to an embodiment of the present disclosure

FIG. 2 is an exemplary first system workflow for the integrated autonomous checkout system of FIG. 1, according to an embodiment of the present disclosure.

FIG. 3 is an exemplary second system workflow for the integrated autonomous checkout system of FIG. 1, according to an embodiment of the present disclosure.

FIG. 4 is an exemplary third system workflow for the integrated autonomous checkout system of FIG. 1, according to an embodiment of the present disclosure.

FIG. 5 is an exemplary fourth system workflow for the integrated autonomous checkout system of FIG. 1, according to an embodiment of the present disclosure.

Wherever possible, the same reference numbers will be used throughout the drawings to represent the same parts.

### DETAILED DESCRIPTION OF THE INVENTION

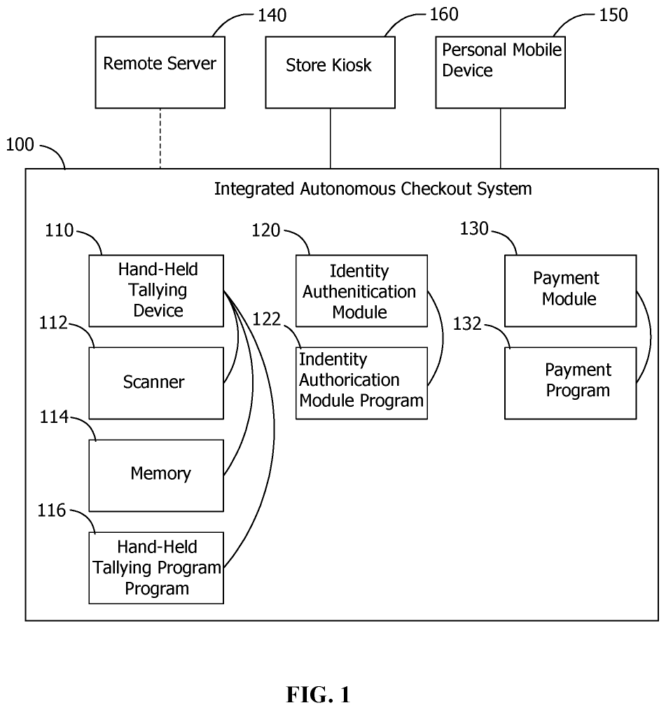

Referring to FIG. 1. in one embodiment, an integrated autonomous checkout system 100 includes a hand-held tallying device 110, an identity authentication module 120, and a payment module 130. The hand-held tallying device 110 includes a scanner 112, memory 114, and a hand-held tallying device program 116 encoded in the memory 114 for recording a tally of items scanned with the scanner 112. The hand-held tallying device 100 is in communication with at least one remote server 140. The identity authentication module 120 includes an identity authentication module program 122 configured to verify an identity of a user as a first authentication factor. The payment module 130 includes a payment module program 132 configured to receive a price corresponding to the tally and direct an electronic payment from an account associated with the user to a seller in response to an instruction provided by the user. The payment module 130 includes a second authentication factor different from the first authentication factor.

In one embodiment, the identity authentication module 120 is disposed as an application in memory of a personal mobile device 150 in the possession of the user, the identity authentication module 120 being in communication with the hand-held tallying device 110 through the at least one remote server 140.

The identity authentication module 120 may be configured to direct a text message communication to the personal mobile device 150 in response to an instruction provided by the user through the hand-held tallying device 110, and direct an authentication confirmation to the payment module 130 in response to fulfilling the first authentication factor by the user. Fulfilling the first authentication factor may be a reply by the user to the text message communication or clicking on a link in the text message communication.

The identity authentication module 120 may be configured to direct an application-based notification communication to an application disposed in the memory of the personal mobile device 150 in response to an instruction provided by the user through the hand-held tallying device 110, and direct an authentication confirmation to the payment module 130 in response to fulfilling the first authentication factor by the user within the application. In one embodiment, the identity authentication module 120 is configured to utilize a facial recognition system or a fingerprint recognition system of the personal mobile device 150 to fulfill the first authentication factor, and direct an authentication confirmation to the payment module 130 in response to fulfilling the first authentication factor by the user. In another embodiment, the identity authentication module 120 is configured to utilize possession of the personal mobile device 150 and access to an application disposed in the memory of the personal mobile device 150 to fulfill the first authentication factor.

The identity authentication module 120 may be disposed as an application in memory of a store kiosk 160, and the identity authentication module 120 may be configured to utilize at least one of a facial recognition system, a fingerprint recognition system, or password verification system to fulfill the first authentication factor and direct an authentication confirmation to the payment module 130 in response to fulfilling the first authentication factor by the user, the identity authentication module 120 being in communication with the hand-held tallying device 110 through the at least one remote server 140.

In one embodiment, the first authentication factor is facial identification and the second identification factor is a password. As used herein, “password” is inclusive of passcodes, personal identification numbers, and combinations thereof.

The payment module 130 may be disposed as an application in the memory 114 of the hand-held tallying device 110 or as an application in the memory of the personal mobile device 150.

The identity authentication module 120 may be programmed to request the price corresponding to the tally from the hand-held tallying device 110 through the at least one remote server 140 and transfer the price corresponding to the tally to the payment module 130. In one embodiment, the identity authentication module 120 is programmed to receive an alphanumeric code generated by the hand-held tallying device 110 to transfer the price corresponding to the tally from the hand-held tallying device 110 to the payment module 130 through the at least one remote server 140. In another embodiment, the identity authentication module 120 is programmed to receive a QR code generated by the hand-held tallying device 110 to transfer the price corresponding to the tally from the hand-held tallying device 110 to the payment module 130 through the at least one remote server 140. In still another embodiment, the identity authentication module 120 is programmed to receive an electronic token generated by the hand-held tallying device 110 by NFC or BLUETOOTH wireless connectivity to transfer the price corresponding to the tally from the hand-held tallying device 110 to the payment module 130 through the at least one remote server 140.

The hand-held tallying device 110 may be configured to be linked to an electronic profile of the user disposed on the at least one remote server 140. The electronic profile of the user may be a loyalty card account.

The hand-held tallying device 110 is physically and/or electronically locked until it is linked to the electronic profile of the user.

The account associated with the user may be a virtual wallet including payment information selected from the group consisting of a savings account, a checking account, a charge account, a debit card account, an automated clearing house account, a credit card account, a wire transfer account, a cryptocurrency account, or combinations thereof. In one embodiment, the virtual wallet is a BRAINTREE™ wallet.

When a user initially creates a virtual wallet on a payment token vault service such as, for example, BRAINTREE, CHASE PAYMENTECH, or FIRST DATA, a customer token is created using a unique customer ID and password, and second, when a customer initiates a shopping trip a device token is generated using the customer token as one of the inputs and a unique device ID as the other. Hence, when a payment transaction is initiated, the requesting service, such as an application server, authenticates the user (user name and password) and then accesses the virtual wallet by passing the two security credentials (i.e. something the customer knows (user name and password) and something the customer/user has (device).) In one embodiment, the integrated autonomous checkout system 100 allows a virtual wallet to be used for payment via or with a shared device (the hand-held tallying device 110). “Customer” and “user” are used interchangeably herein.

In one embodiment, in order to allow a merchant supplied device (the hand-held tallying device 110) to securely conduct customer transactions via the store network, the shared device is uniquely associated with both the customer and the store. The at least one remote server 140, via the store wireless network, may configure the hand-held tallying device 110 with a unique device ID representing both the store and customer. This ensures that the hand-held tallying device 110 obtained by the customer is associated with the store. This improves both the customer data security and the store data and network security.

The unique device ID may include numerous components. The unique device ID may include a banner identifier of two or more, three or more, and/or four or more characters to identify the store's brand. The unique device ID may additionally include a store code of two or more, three or more, and/or four or more characters to identify a particular store location under that banner.

The unique device ID also includes a sequence of characters uniquely identifying the customer. The customer code may be two or more, three or more, four or more, and/or five or more characters. In some embodiments, the customer code may be derived wholly or partially from an existing customer number, such as a loyalty card number. In one embodiment, the customer code may include the last five digits of the customer's loyalty card number.

The unique device ID may also include a token generated by the at least one remote server 140. The token may be used as an added security measure. In some embodiments, the token may be set to expire after the customer's transaction is successfully completed. In some embodiments, the token may be set to expire after a predetermined period of time. In some embodiments, the token may be reset by a store representative. As a further security measure, the entire unique device ID may also be set to expire after a predetermined period of time.

In one embodiment, the characters may be digits. In one embodiment, the characters may be an alphanumeric character. In one embodiment, the characters may be represented by one or more of ASCII American Standard Code Information Interchange, Extended Binary Coded Decimal Interchange Code, Unicode and combinations thereof.

Upon entering a store, a customer may approach a source of the merchant-supplied hand-held tallying devices 110, such as a store kiosk 160 or service desk. The customer may scan their loyalty card to start a session (trip), thus initiating the configuration of a hand-held tallying device 110 with a unique ID. The at least one remote server 140 then assigns the hand-held tallying device 110 to the customer allowing the customer to retrieve the device from the store kiosk 160 or service desk. In some embodiments, the at least one remote server 140 may log the unique device identifier (customer/device pair), during assignment to the customer. If the customer shops at different store locations, a unique device ID is generated at each store.

The at least one remote server 140 assigns the hand-held tallying device 110 a unique IP address from a limited reserved range of Dynamic Host Configuration Protocol (DHCP) IPs. Dynamic Host Configuration Protocol (DHCP) is a network management protocol used on UDP/IP networks whereby a DHCP server dynamically assigns an IP address and other network configuration parameters to each device on a network, so they can communicate with other IP networks.

In some embodiments, the hand-held tallying device 110 may further be authenticated by the server prior to customer use. In one embodiment, the authentication is conducted via a secured network configured as a Virtual LAN (VLAN). The secured network may additionally be encrypted. In one embodiment, the VLAN employs an AES 256 encryption key.

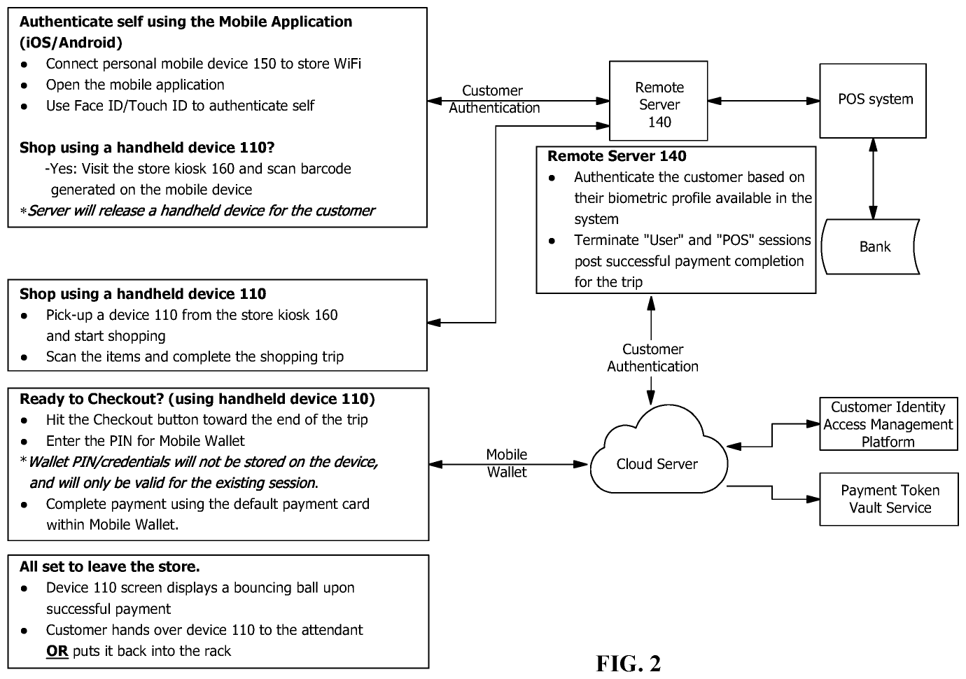

Referring to FIG. 2, in one exemplary embodiment, a customer enters a store, connects a personal mobile device 150 to the store's wireless network, and launches an application on the personal mobile device 150. The application requests the customer to use facial recognition or fingerprint recognition to authenticate the customer's identity. The application authenticates the customer and prompts a message on the personal mobile device 150, providing an option to shop using the personal mobile device 150 or the hand-held tallying device 110. If the customer selects shopping using the personal mobile device 150, the customer may either use a traditional checkout after shopping or make a payment through a virtual wallet already setup on the personal mobile device 150. If the customer selects shopping using the hand-held tallying device 110, the application will unlock a hand-held tallying device 110 and link and the hand-held tallying device 110 to the loyalty card account of the customer. The application may unlock the hand-held tallying device 110 by any suitable method, including displaying a bar code to be read by a kiosk storying hand-held tallying devices 110, or communication with said kiosk through NFC, BLUETOOTH, or WiFi wireless communication. The customer will then shop using the hand-held tallying device 110 to scan selected items and, when the shopping is complete, will be prompted to enter a password into the hand-held tallying device 110 as a second authentication factor to access a virtual wallet and complete payment. In one embodiment, any credentials which are entered by the customer are stored only in volatile memory and are therefore unable to be exposed to a third party even if the hand-held tallying device 110 or the personal mobile device 150 is compromised.

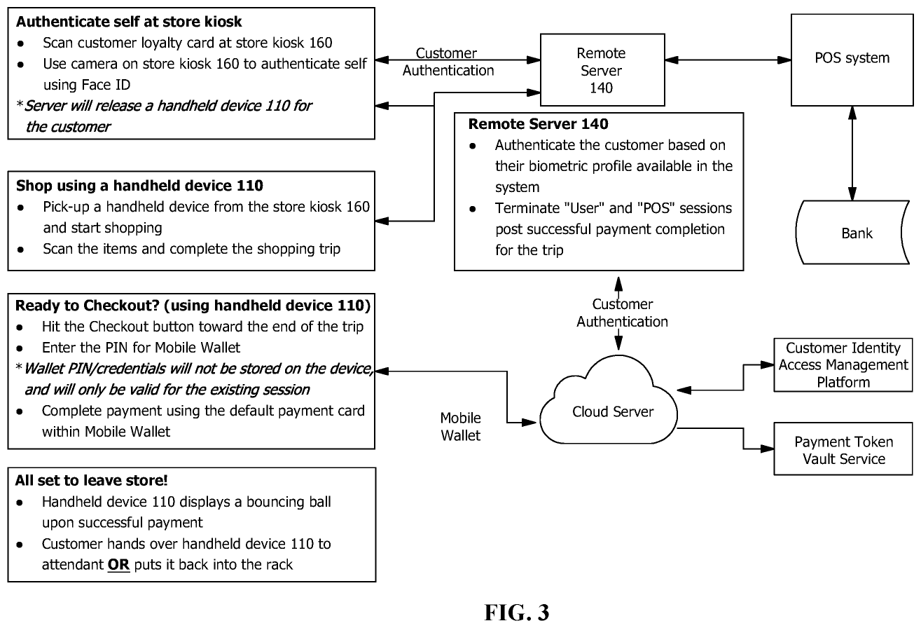

Referring to FIG. 3, in one exemplary embodiment, a customer enters a store and interacts with a store kiosk 160, scanning a loyalty card or accessing a loyalty card account with suitable identifying information. The store kiosk 160 then verifies the customer's identity with facial recognition, fingerprint recognition, or a password. Once authenticated, the store kiosk 160 releases a hand-held tallying device 110 linked to the customer's loyalty card account. The customer will then shop using the hand-held tallying device 110 to scan selected items and, when the shopping is complete, will be prompted to enter a password into the hand-held tallying device 110 as a second authentication factor to access a virtual wallet and complete payment. In one embodiment, any credentials which are entered by the customer are stored only in volatile memory and are therefore unable to be exposed to a third party even if the hand-held tallying device 110 or the store kiosk 160 is compromised.

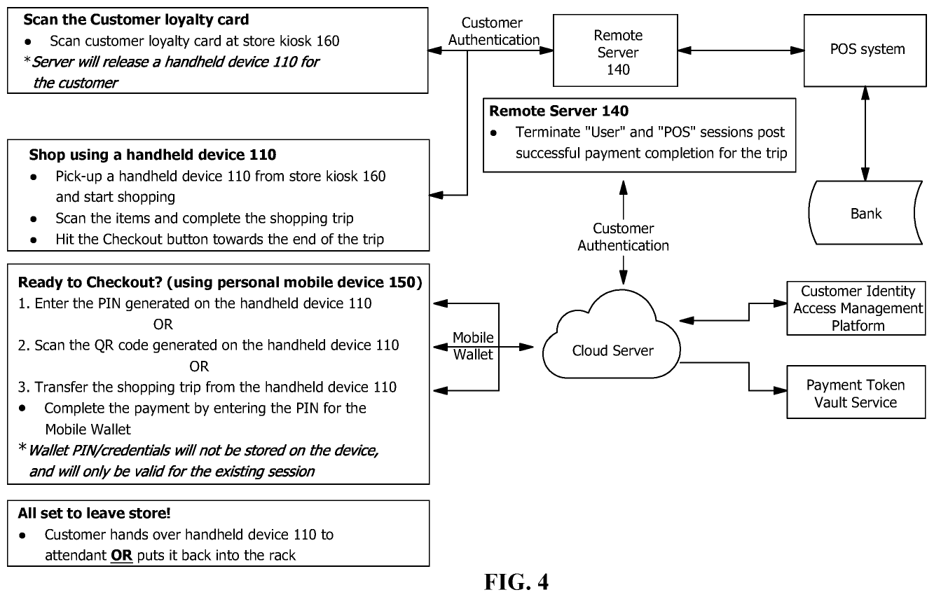

Referring to FIG. 4, in one exemplary embodiment, a customer enters a store and interacts with a store kiosk 160, scanning a loyalty card or accessing a loyalty card account with suitable identifying information. The store kiosk 160 then releases a hand-held tallying device 110 linked to the customer's loyalty card account. The customer will then shop using the hand-held tallying device 110 to scan selected items. When the shopping is complete, the hand-held tallying device 110 will either display an alphanumeric code or a QR code, or will transmit an electronic token by NFC, BLUETOOTH, WiFi, or other wireless connectivity, which will be read by an application on the customer's personal mobile device 150 to transfer the tally from the hand-held tallying device 110 to the personal mobile device, or the customer will direct the application on the personal mobile device to request a download transfer of the tally through the at least one remote server 140. After the tally has been transferred, the customer will be prompted to enter a password into the personal mobile device 150 as a second authentication factor to access a virtual wallet and complete payment. In one embodiment, any credentials which are entered by the customer are stored only in volatile memory and are therefore unable to be exposed to a third party even if the hand-held tallying device 110, the store kiosk 160, or the personal mobile device 150 is compromised.

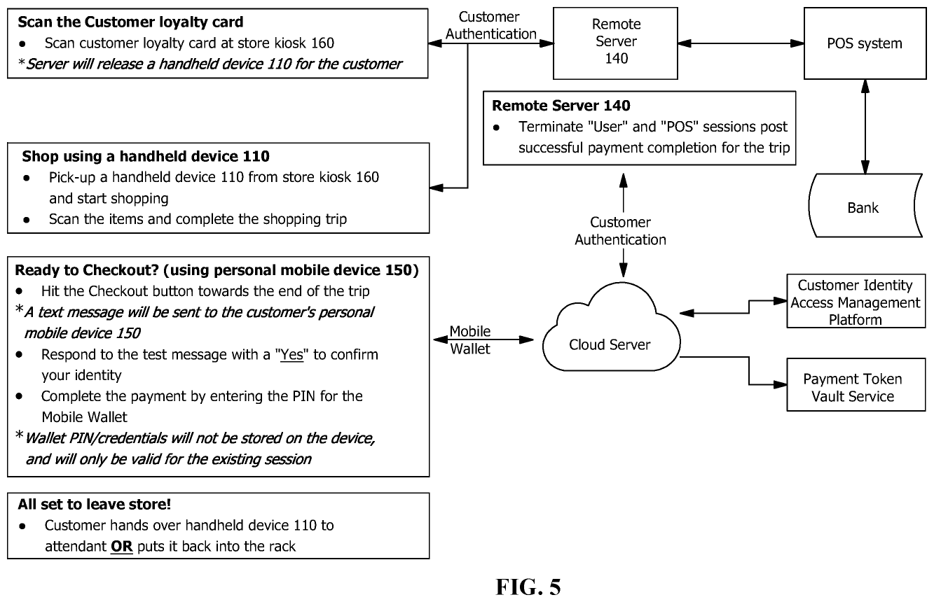

Referring to FIG. 5, in one exemplary embodiment, a customer enters a store and interacts with a store kiosk 160, scanning a loyalty card or accessing a loyalty card account with suitable identifying information. The store kiosk 160 then releases a hand-held tallying device 110 linked to the customer's loyalty card account. The customer will then shop using the hand-held tallying device 110 to scan selected items. When the shopping is complete, the hand-held tallying device 110 directs the at least one remote server 150 to send a text message communication, email communication, or in-application communication to the personal mobile device 150. The customer may reply to the text message communication, email communication, or in-application communication, or click on a link in the text message communication or email communication to verify the customer's identity. The customer will be prompted to enter a password into the personal mobile device 150 as a second authentication factor to access a virtual wallet and complete payment. In one embodiment, any credentials which are entered by the customer are stored only in volatile memory and are therefore unable to be exposed to a third party even if the hand-held tallying device 110, the store kiosk 160, or the personal mobile device 150 is compromised.

The steps of the foregoing exemplary embodiment may be recombined with one another in any suitable fashion, or with any of the other embodiment disclosed herein, provided that at least two-factor authentication is maintained. Any requirement for a password may be replaced with fingerprint or facial recognition as the second authorization factor provided that the first authorization factor is not the same.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated autonomous checkout system, comprising:
a hand-held tallying device including a scanner, memory, and a hand-held tallying device program encoded in the memory of the hand-held tallying device for recording a tally of items scanned with the scanner, the hand-held tallying device being in communication with at least one remote server;
an identity authentication module including an identity authentication module program configured to verify an identity of a user as a first authentication factor; and
a payment module including a payment module program configured to receive a price corresponding to the tally and direct an electronic payment from an account associated with the user to a seller in response to an instruction provided by the user, the payment module including a second authentication factor different from the first authentication factor.

2. The integrated autonomous checkout system of claim 1, wherein the identity authentication module is disposed as an application in memory of a personal mobile device in the possession of the user, the identity authentication module being in communication with the hand-held tallying device through the at least one remote server.

3. The integrated autonomous checkout system of claim 2, wherein the identity authentication module is configured to direct a text message communication to the personal mobile device in response to an instruction provided by the user through the hand-held tallying device, and direct an authentication confirmation to the payment module in response to fulfilling the first authentication factor by the user.

4. The integrated autonomous checkout system of claim 3, wherein fulfilling the first authentication factor is a reply by the user to the text message communication or clicking on a link in the text message communication.

5. The integrated autonomous checkout system of claim 2, wherein the identity authentication module is configured to direct an application-based notification communication to an application disposed in the memory of the personal mobile device in response to an instruction provided by the user through the hand-held tallying device, and direct an authentication confirmation to the payment module in response to fulfilling the first authentication factor by the user within the application.

6. The integrated autonomous checkout system of claim 2, wherein the identity authentication module is configured to utilize a facial recognition system of the personal mobile device to fulfill the first authentication factor, and direct an authentication confirmation to the payment module in response to fulfilling the first authentication factor by the user.

7. The integrated autonomous checkout system of claim 2, wherein the identity authentication module is configured to utilize a fingerprint recognition system of the personal mobile device to fulfill the first authentication factor, and direct an authentication confirmation to the payment module in response to fulfilling the first authentication factor by the user.

8. The integrated autonomous checkout system of claim 2, wherein the identity authentication module is configured to utilize possession of the personal mobile device and access to an application disposed in the memory of the personal mobile device to fulfill the first authentication factor.

9. The integrated autonomous checkout system of claim 1, wherein the identity authentication module is disposed as an application in memory of a store kiosk and the identity authentication module is configured to utilize at least one of a facial recognition system, a fingerprint recognition system, or password verification system to fulfill the first authentication factor and direct an authentication confirmation to the payment module in response to fulfilling the first authentication factor by the user, the identity authentication module being in communication with the hand-held tallying device through the at least one remote server.

10. The integrated autonomous checkout system of claim 1, wherein the payment module is disposed as an application in the memory of the hand-held tallying device.

11. The integrated autonomous checkout system of claim 1, wherein the payment module is disposed as an application in the memory of the personal mobile device.

12. The integrated autonomous checkout system of claim 1, wherein the identity authentication module is programmed to request the price corresponding to the tally from the hand-held tallying device through the at least one remote server and transfer the price corresponding to the tally to the payment module.

13. The integrated autonomous checkout system of claim 12, wherein the identity authentication module is programmed to receive an alphanumeric code generated by the hand-held tallying device to transfer the price corresponding to the tally from the hand-held tallying device to the payment module through the at least one remote server.

14. The integrated autonomous checkout system of claim 12, wherein the identity authentication module is programmed to receive a QR code generated by the hand-held tallying device to transfer the price corresponding to the tally from the hand-held tallying device to the payment module through the at least one remote server.

15. The integrated autonomous checkout system of claim 12, wherein the identity authentication module is programmed to receive an electronic token generated by the hand-held tallying device by NFC wireless connectivity to transfer the price corresponding to the tally from the hand-held tallying device to the payment module through the at least one remote server.

16. The integrated autonomous checkout system of claim 1, wherein the hand-held tallying device is configured to be linked to an electronic profile of the user disposed on the at least one remote server.

17. The integrated autonomous checkout system of claim 16, wherein the electronic profile of the user is a loyalty card account.

18. The integrated autonomous checkout system of claim 16, wherein the hand-held tallying device is physically and electronically locked until it is linked to the electronic profile of the user.

19. The integrated autonomous checkout system of claim 1, wherein the first authentication factor is facial identification and the second identification factor is a password.

20. The integrated autonomous checkout system of claim 1, wherein the account associated with the user is a virtual wallet including payment information selected from the group consisting of a savings account, a checking account, a charge account, a debit card account, an automated clearing house account, a credit card account, a wire transfer account a cryptocurrency account, and combinations thereof.
